(19) United States
(12) Patent Application Publication
(10) Pub. No.: US 2008/0145030 A1
(43) Pub. Date: Jun. 19, 2008

(54) Camera apparatus and reproduction control method in camera apparatus

(75) Inventors: Hidetsugu Yamamiya, Tokyo (JP); Tatsuro Abe, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/976,580

(22) Filed: Oct. 25, 2007

(30) Foreign Application Priority Data
Dec. 19, 2006 (JP) 2006-341717

(51) Int. Cl. H04N 5/00

(52) U.S. Cl. 386/117

(57) ABSTRACT

According to one embodiment, a camera apparatus includes a reproduction control unit for conducting control such that when skip setting for skip-reading a portion of moving image data has been performed for a particular chapter of moving image data indicating a shot video, the shot video is reproduced without using the moving image data constituting the chapter for which the skip setting has been performed.

### CROSS-REFERENCE TO RELATED APPLICATIONS

This application is based upon and claims the benefit of priority from Japanese Patent Application No. 2006-341717, filed Dec. 19, 2006, the entire contents of which are incorporated herein by reference.

### BACKGROUND

1. Field

One embodiment of the invention relates to a camera apparatus for generating moving image data indicating a shot video which has been shot, such as a digital camera, a vide camera or the like, and a reproduction control method in the camera apparatus.

2. Description of the Related Art

Conventionally, there is a known camera apparatus (also called an electronic camera apparatus) for capturing an optical image of a subject as a still image or a moving image, converting the shot image into image data, and electronically saving it. Conventional camera apparatuses include a digital camera mainly shooting the still image and a video camera mainly shooting the moving image.

On the other hand, video recording/reproducing apparatus is also widely used which records video data on a recording medium such as an optical disk or the like and reproduces the recorded video data. For instance, Japanese Patent Application Publication (KOKAI) No. 2002-230950 (Patent Document 1) discloses a video recording/reproducing apparatus that sets a skip time for skipping a reproduction time of video data recorded on the optical disk by a predetermined time and a reproduction time for reproducing the video data and repeats skip and reproduction of the video.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing main components of a camera apparatus according to an embodiment of the invention;

FIG. 2 is an exemplary view showing the data structure of moving image data compressed by a compression/decompression processing unit in compliance with MPEG-2 in the embodiment;

FIG. 3 is an exemplary view showing the data structure of the moving image data compressed by the compression/decompression processing unit in compliance with MPEG-2 in the same manner as in FIG. 2, showing GOPs in conjunction with a chapter table in the embodiment;

FIG. 4 is an exemplary view showing an example of a chapter edit menu in the embodiment;

FIG. 5 is an exemplary flowchart showing a procedure of setting chapter skip in the embodiment;

FIG. 6 is an exemplary flowchart showing a procedure of releasing the chapter skip in the embodiment;

FIG. 7 is an exemplary flowchart showing a procedure of setting a release password in the embodiment;

FIG. 8 is an exemplary flowchart showing a procedure of releasing the release password in the embodiment;

FIG. 9 is an exemplary flowchart showing an operation procedure of skip reproduction or normal reproduction in the embodiment; and

FIG. 10 is an exemplary view showing an example of the moving image data to be skip-reproduced in the embodiment.

### DETAILED DESCRIPTION

Various embodiments according to the invention will be described hereinafter with reference to the accompanying drawings. In general, according to one embodiment of the invention, a camera apparatus includes a reproduction control unit for conducting control such that when skip setting for skip-reading a portion of moving image data has been performed for a particular chapter of moving image data indicating a shot video, the shot video is reproduced without using the moving image data constituting the chapter for which the skip setting has been performed.

Further, a camera apparatus, includes: a moving image data generating device for generating moving image data indicating a shot video; a chapter data generating unit for generating chapter data determining a reproduction start point in the moving image data generated by the moving image data generating device; and a reproduction control unit for conducting control such that when skip setting for skip-reading a portion of moving image data has been performed for the chapter data, the shot video is reproduced without using corresponding moving image data corresponding to the chapter data for which the skip setting has been performed.

Furthermore, in a reproduction control method in a camera apparatus including a moving image data generating device for generating moving image data indicating a shot video, the following is performed. Namely, control is conducted such that when skip setting for skip-reading a portion of moving image data has been performed for a particular chapter of moving image data indicating a shot video, the shot video is reproduced without using the moving image data constituting the chapter for which the skip setting has been performed.

(Components of Camera Apparatus)

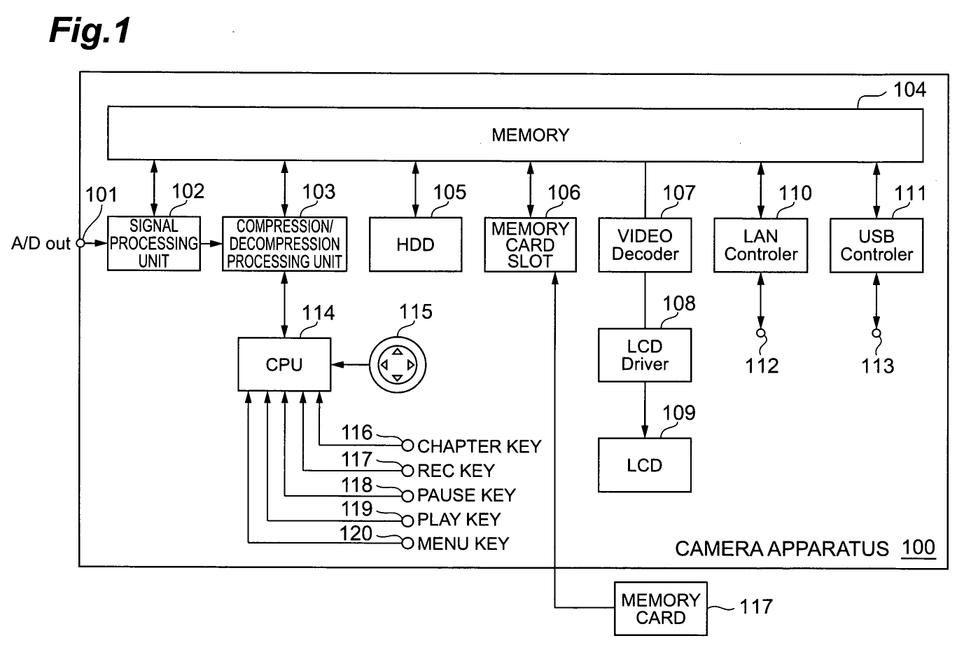

FIG. 1 is a block diagram showing main components of a camera apparatus 100 according to an embodiment of the present invention. The camera apparatus 100 shown in FIG. 1 is a digital video camera apparatus shooting mainly a moving image and also capable of shooting a still image.

The camera apparatus 100 handles data compressed in compliance with MPEG-2 when shooting and reproducing the moving image. When reproducing a moving image, the camera apparatus 100 can easily realize trick reproduction such as reverse reproduction, high-speed reproduction, high-speed reverse reproduction, frame forward, and frame rewind, in addition to normal reproduction. Further, unlike a case in which a magnetic tape is employed as an image data recording medium, a random-accessible recording medium such as a later-described HDD 105 or a memory card 117 is employed in the camera apparatus 100. This allows a user to easily search a video that the user wants to see.

The camera apparatus 100 includes a digital signal output unit 101, a signal processing unit 102, a compression/decompression processing unit 103, a memory 104, and the HDD (Hard Disk Drive) 105.

The camera apparatus 100 also includes a memory card slot 106, a video decoder 107, an LCD (Liquid Crystal Display) driver 108, an LCD 109, a LAN controller 110, and a USB controller 111. The camera apparatus 100 further includes a LAN terminal 112, a USB terminal 113, a CPU 114, an operation device 115, and five operation keys (a chapter key 116, a REC key 117, a PAUSE key 118, a PLAY key 119, and a menu key 120).

The digital signal output unit 101 converts an analog electric signal, which is generated by a CCD (Charge Coupled Device) using an optical image of a subject obtained through a not-shown lens, into a digital signal and outputs the digital signal to the signal processing unit 102.

The signal processing unit 102 has a function as a moving image data generating device for performing image processing on the inputted digital signal to generate moving image data indicating a shot video actually shot. Note that the generated moving image data is once stored in the memory 104.

The compression/decompression processing unit 103 compresses the moving image data exported from the memory 104 in compliance with MPEG-2 to produce compressed moving image data, or compresses still image data in compliance with JPEG to produce compressed still image data. Further, in accordance with an instruction from the CPU 114, the compression/decompression processing unit 103 decompresses the compressed moving image data and the compressed still image data.

The memory 104 temporarily stores data to be processed by the signal processing unit 102, and data to be processed by the compression/decompression processing unit 103.

The HDD 105 is an external memory apparatus for recording the moving image data which has been compressed (compressed moving image data), sound data which has been compressed, and the compressed still image data to an HD (Hard Disc) built therein. The HDD 105 reads/writes data from/to the HD (Hard Disc) on a random access basis.

The memory card 117 such as an SD memory card (Secure Digital memory card) is inserted into the memory card slot 106, and the memory card slot 106 reads/writes data from/to the inserted memory card 117. In the memory card 117, the compressed moving image data and the like is recorded.

In order to display the shot video that is shot using the compressed moving image data, the video decoder 107 performs a decoding process on the moving image data and outputs the resulting data to the LCD driver 108. The video decoder 107 is a software decoder realized with a decoding program.

The LCD driver 108 converts the decoded moving image data received from the video decoder 107 into a display signal compatible with an interface of the LCD 109. The LCD 109 displays the shot video using-the display signal outputted from the LCD driver 108.

In accordance with the instruction of the CPU 114, the LAN controller 110 transfers the moving image data taken from the memory 104 to a not-shown external apparatus (for example, a DVD recorder or an HDD recorder) connected via the LAN terminal 112. Besides, the LAN controller 110 outputs the moving image data imported from the external apparatus via the LAN terminal 112 to the memory 104.

In accordance with the instruction of the CPU 114, the USB controller 111 transfers the moving image data taken from the memory 104 to a not-shown external apparatus (for example, a personal computer) connected via the USB terminal 113. Besides, the USB controller 111 outputs the moving image data imported from the external apparatus via the USB terminal 113 to the memory 104.

In accordance with a program stored in a not-shown ROM, the CPU 114 operates as various units (a reproduction control unit, a chapter data generating unit, a skip setting unit, a skip setting release unit, and a judging unit) being features of the invention. Further, the CPU 114 inputs/outputs a signal into/from the other components to control the entire operation or the respective sequences of the camera apparatus 100.

The operation device 115 includes a JOG dial and a cross key. The operation device 115 is an operation device operated by a user to select and perform various functions (for example, stopping reproduction, stopping shooting, and the like) in the camera apparatus 100. Further, when the JOG dial is operated during reproduction of the moving image, the reproduction speed is adjusted in accordance with the operation.

The chapter 116 inputs a chapter generating instruction to the CPU 114 according to a pressing operation by the user. The chapter generating instruction is data instructing the CPU 114 to generate later-described chapter data (for example, later-described chapter data 331 and so on) and record the generated chapter data to a chapter table 330. The REC key 117 inputs an instruction to start recording to the CPU 114 according to a pressing operation by the user. The PAUSE key 118 inputs an instruction to pause recording or reproduction to the CPU 114.

The PLAY key 119 inputs an instruction to start reproduction of the moving image (shot video) to the CPU 114. The menu key 120 inputs an instruction signal to display a later-described chapter edit menu 340 into the CPU 114 according to a pressing operation by the user.

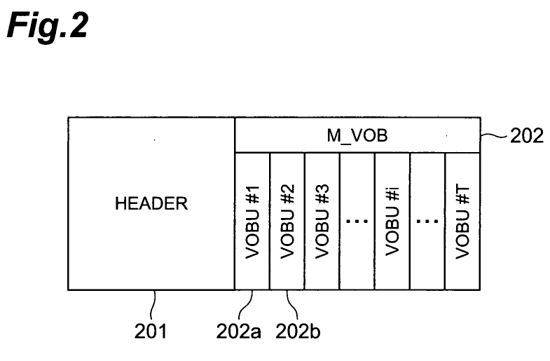

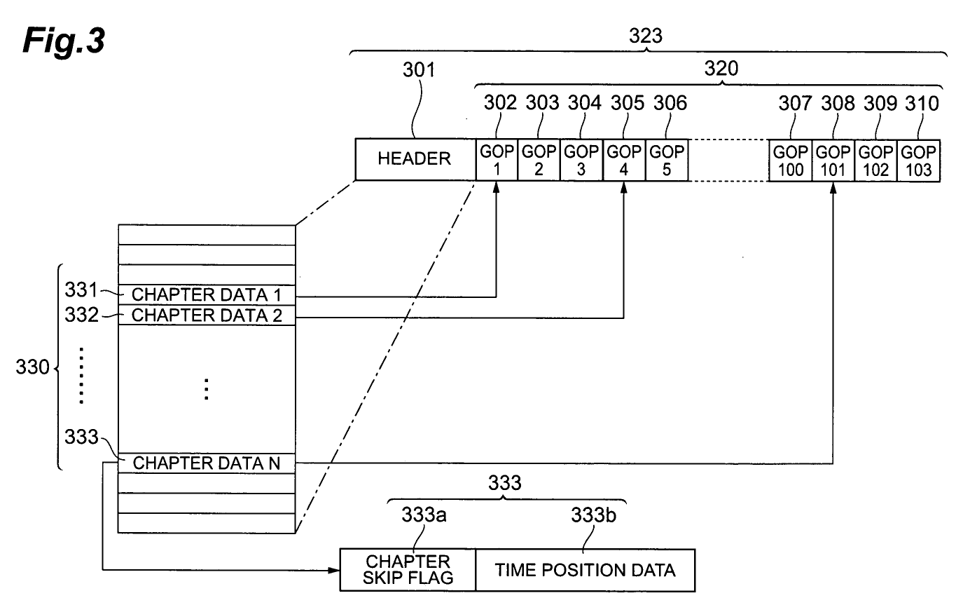

Next, the data structure of the moving image data compressed in compliance with MPEG-2 by the compression/decompression processing unit 103 will be described with reference to FIG. 2 and FIG. 3. Here, FIG. 2 is a view showing the data structure of the moving image data compressed in compliance with MPEG-2 by the compression/decompression processing unit 103.

The moving image data includes a header section 201 and a data section 202. The header section 201 includes a VOBU-ENT information section in which the size of each VOBU (Video Object Block Unit) constituting the data section 202. The data section 202 includes a plurality of VOBUs (VOBUs 202a, 202b, and so on).

The number of VOBUs is proportional to the shooting time. The VOBU includes the moving image data corresponding to 0.5 seconds compressed in compliance with MPEG-2, that is, one GOP (Group of Pictures) which will be described later and a lot of header information. For example, in case of a shooting time of 10 minutes, 1200 GOPs are generated which is found by 10 minutes×60 sec/0.5. Since the size of each VOBU is recorded in the VOBU-ENT information section of the header section 201, the size information of each of 1200 GOPs is recorded.

Similarly, FIG. 3 is a view showing the structure of moving image data 323 compressed in compliance with MPEG-2 by the compression/decompression processing unit 103, showing GOPs in conjunction with a chapter table 330. When reproducing the shot video using the moving image data 323 in the camera apparatus 100, a moving image in a certain unit or some combined moving images constitute(s) a GOP so that the image(s) can be reproduced independently in a unit of GOP. The GOP includes the moving image data corresponding to 15 frames.

The moving image data 323 includes a header 301 and a moving image stream 320 indicating a shot video actually shot.

In the header 301, management information is recorded, such as initial data required by the video decoder 107 to decode and reproduce the shot video such as the size of the image, a pixel aspect ratio and so forth.

The header 301 also includes the chapter table 330. In the chapter table 330, generated chapter data is recorded. FIG. 3 shows a state in which N pieces of chapter data (chapter data 331, 332, and 333) are recorded in the chapter table 330 (however, illustration of some of the chapter data is omitted).

Each chapter data includes a chapter skip flag 333a and time position data (PTM (Presentation Time), also referred to as time position information) 333b. The time position data 333b indicates the position of a specific GOP of the GOPs included in the moving image stream 320.

The chapter skip flag 333a indicates whether or not to skip by chapter (whether or not to skip reading). To skip, the flag is turned ON so that “1” is set in this embodiment. Not to skip, the flag is turned OFF so that “0” is set in this embodiment (the skip of the moving image data by chapter is also referred to as chapter skip).

When chapter data is recorded, “0” is set as an initial value in the chapter skip flag 333a which is set to OFF. Note that it is only required that the chapter skip flag 333a can be distinguished ON from OFF, in which other than “1” and “0” may be set therein.

The chapter data 331, 332, and 333 include respective time position data 333b of the GOPs 302, 305, and 308, and are brought into correspondence with the GOPs using the respective time position data 333b. Further, the chapter data indicates the reproduction start point of the moving image data.

The moving image stream 320 is configured as a data stream including a plurality of GOPs (GOPs 302 to 310), and each GOP is recorded by 0.5 seconds. Each GOP is the unit of edit process using the operation device 115, and is data corresponding to a shooting time of 0.5 seconds.

(Operation Details of Camera Apparatus)

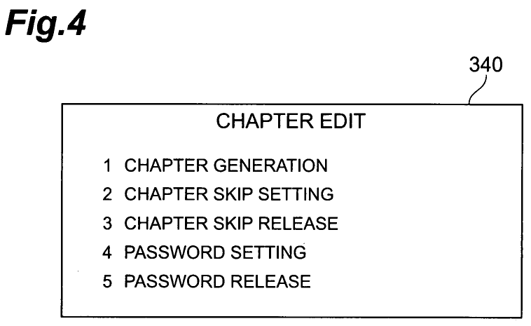

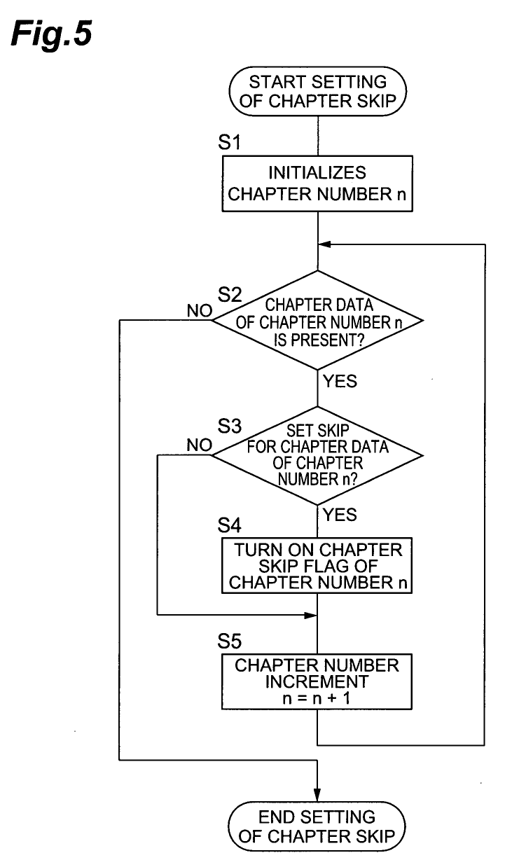

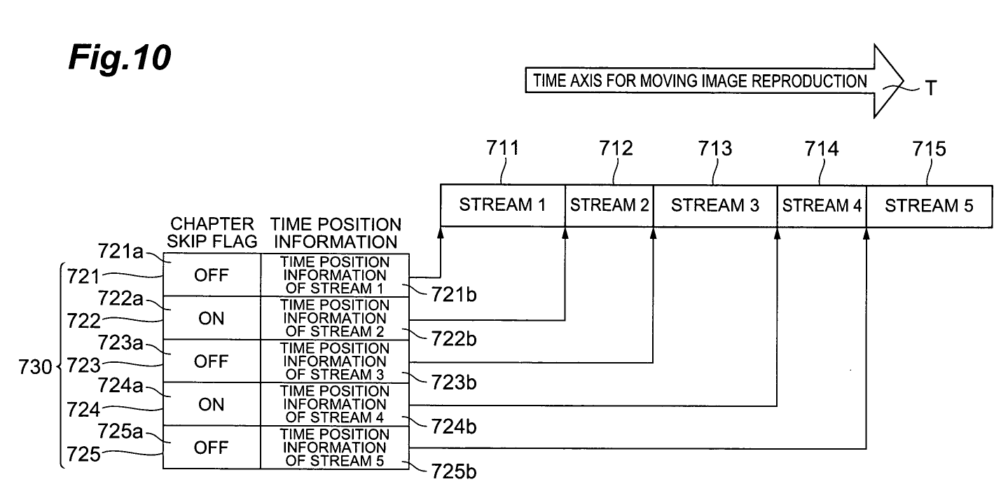

Next, operation details of the camera apparatus 100 will be described with reference to FIG. 4 to FIG. 10. FIG. 4 is an illustration showing an example of the chapter edit menu 340 displayed on the LCD 109. FIG. 5 to FIG. 9 are flowcharts showing various operation procedures in the camera apparatus 100, and FIG. 10 is a view showing an example of the moving image data to be skip-reproduced.

In the camera apparatus 100, the chapter edit menu 340 is displayed on the LCD 109 according to an operation of pressing the menu key 120 by the user. The chapter edit menu 340 includes, as shown in FIG. 4, five items “1 Chapter Generation,” “2 Chapter Skip Setting,” “3 Chapter Skip Release,” “4 Password Setting,” and “5 Password Release” so that the user can operate the operation device 115 to select the item to execute.

(Generation of Chapter Data)

When the user selects “1 Chapter Generation,” the chapter data is generated as described below. The user first selects “1 Chapter Generation.”

Next, the user performs an operation of pressing the PLAY key 119 to start reproduction of the moving image, and performs an operation of pressing the chapter key 116 at the point in time when a desired moving image is displayed and when a moving image unsuitable for reproduction such as a moving image that the user does not want another person to see, while checking the reproduced moving image on the LCD 109.

Then, the CPU 114 performs the operation as a chapter data generating unit. This causes the CPU 114 to generate the chapter data including the time position information corresponding to the GOP at a timing when the operation of pressing the chapter key 116 is performed, and record it into the chapter table 330.

(Setting of Chapter Skip or Release of Chapter Skip)

Next, when the user selects “2 Setting of Chapter Skip,” setting of the chapter skip is performed following the flowchart shown in FIG. 5. This can set whether or not to skip each generated chapter data.

When starting the operation, the CPU 114 initializes a chapter number n (sets “1”) (S1). This chapter number n is used as an index indicating individual chapter data.

Subsequently, the CPU 114 judges whether the chapter data of the chapter number n is present or not in the chapter table 330 (S2). When the chapter data of the chapter number n is present here, the CPU 114 proceeds to S3, and when not present, the CPU 114 ends the setting of the chapter skip.

Subsequently, the CPU 114 judges whether or not to skip the chapter data of the chapter number n, for example, based on the instruction signal from the operation device 115 (S3). When judging to skip the data, the CPU 114 proceeds to S4, and otherwise to S5. When proceeding to S4, the CPU 114 performs the operation as a skip setting unit to perform skip setting by turning ON the skip flag for the chapter data of the chapter number n (setting “1”). Subsequently, the CPU 114 adds “1” to the chapter number n (S5) and then returns to S2.

The above operations allows the user to select whether to turn ON the skip flag or to keep it OFF for the individual chapter data so as to turn ON or OFF the skip flag for each chapter data so that the user can perform skip setting for each chapter. Note that when no skip setting is performed, the skip flag is set at OFF as the initial value.

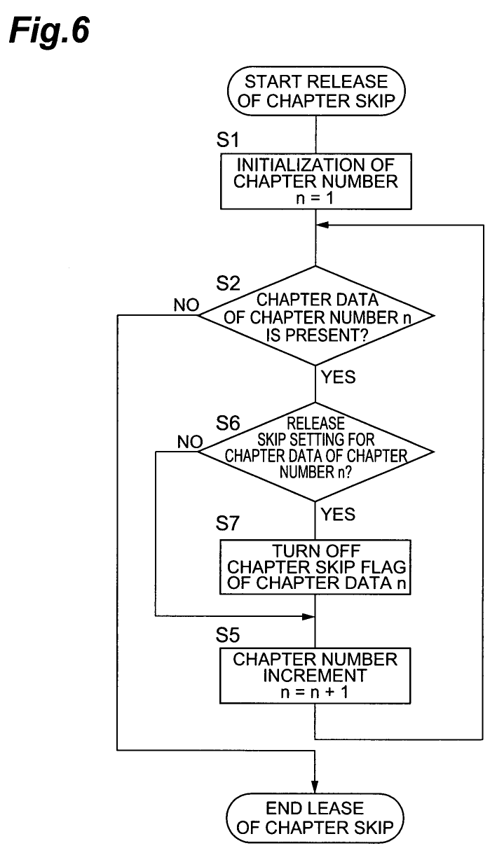

When the user selects “3 Chapter Skip Release,” release of chapter skip is performed following the flowchart shown in FIG. 6. This can release the setting of the chapter skip (skip setting) for the chapter data.

The flowchart in FIG. 6 is the same as the flowchart in FIG. 5 except that S3 and S4 are replaced with S6 and S7, respectively. In S6, the CPU 114 judges whether or not to release the skip setting for the chapter data of the chapter number n, for example, based on the instruction signal from the operation device 115 (S6).

When judging to release the skip setting, the CPU 114 proceeds to S7, and otherwise to S5. When proceeding to S7, the CPU 114 performs the operation as a skip setting release unit to turn OFF the skip flag for the chapter data of the chapter number n (set “0”).

The above operations allows the user to turn OFF the skip flag even after turning ON the skip flag so that the user can release the skip setting for each chapter.

(Password Setting or Release)

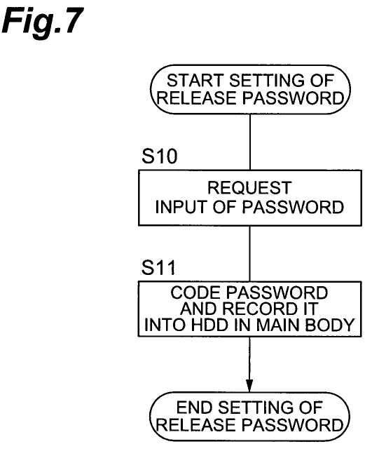

Next, when the user selects “4 Password Setting,” a password for releasing the setting of the chapter skip (hereinafter, referred to as a “release password”) is set following the flowchart shown in FIG. 7. The release password is a password for releasing the setting of the chapter skip for the chapter data for which the chapter skip has been set, to reproduce the moving image data corresponding to that chapter data (corresponding moving image data). Releasing the setting of the chapter skip for the chapter data allows the corresponding moving image data to be reproduced without skip.

Setting of such a release password ensures that even if the chapter skip has been set for the chapter data, the corresponding moving image data can be reproduced on condition of input of the release password (described later in detail).

After starting the operation, the CPU 114 requests the user to input the release password, for example, by displaying a message on the LCD 109 (S10). When the user inputs the password by operating the operation device 115, the CPU 114 performs the operation as a password setting unit to code the inputted password and then record it into the HDD 105 as the release password, and then ends the operation (S1).

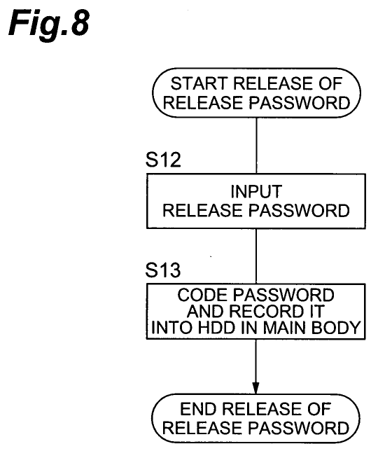

When the user selects “5 Password Release,” the set release password can be released (deleted) following the flowchart shown in FIG. 8.

After starting the operation, the CPU 114 requests the user to input the release password, for example, by displaying a message on the LCD 109 (S12). When the user inputs the release password by operating the operation device 115, the CPU 114 performs the operation as a password release unit to delete the inputted release password from the HDD 105 and then ends the operation (S13).

(Operation Details of Skip Reproduction)

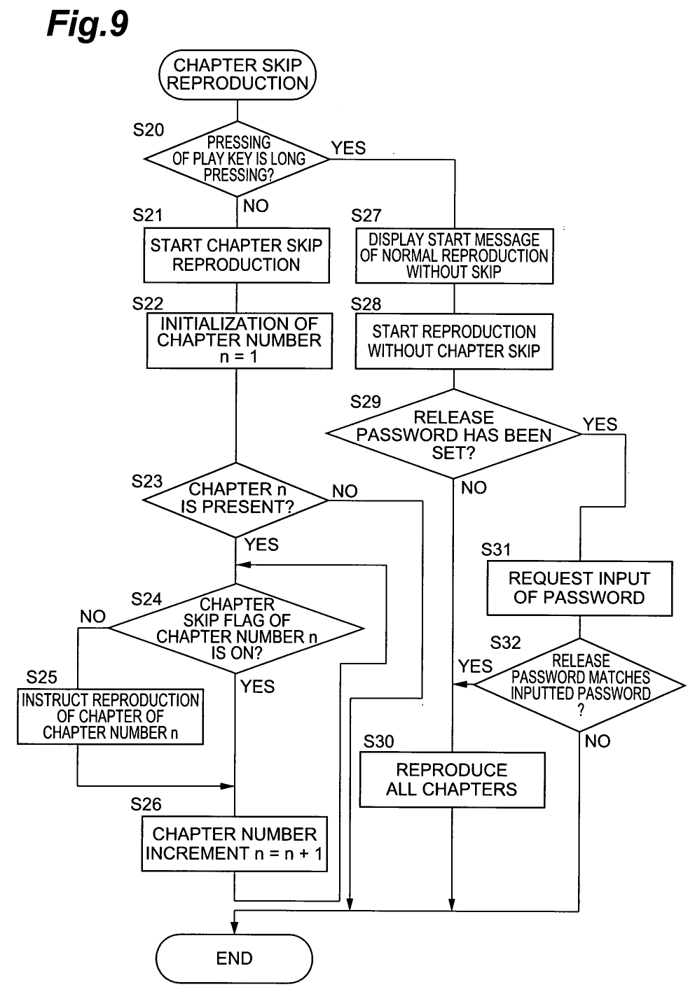

The procedure of reproducing the moving image data when the user has set the chapter skip for the chapter data will be described with reference to FIG. 9.

The user first designates the moving image data to reproduce in a not-shown list display screen of the moving data. Subsequently, when the user performs an operation of pressing the PLAY key 119 to start reproduction of the moving image data, the CPU 114 judges whether the operation of pressing the PLAY key 119 at that time was a long pressing (a pressing for one second or more is the long pressing in this embodiment) (S20). When the CPU 114 judges that the pressing is not the long pressing, the CPU 114 performs operation as a reproduction control unit to instruct the HDD 105 and so on to start skip reproduction (S21), whereas when the CPU 114 judges that it is the long pressing, the CPU 114 starts normal reproduction (S27).

Subsequently, when starting the skip reproduction, the CPU 114 initializes the chapter number n (sets “1”) (S22), and then judges whether the chapter data of the chapter number n is present or not (S23). When the chapter data of the chapter number n is present, the CPU 114 judges whether or not the chapter skip flag is ON for the chapter data of the chapter number n (S24).

Since the chapter skip is set here for the chapter data when its chapter skip flag is ON, the CPU 114 adds “1” to the chapter number n (S26) without executing S25 (without reproducing the moving image data). Besides, since the chapter skip is not set for the chapter data when its chapter skip flag is not ON (when it is OFF), the CPU 114 instructs the HDD 105 and so on to reproduce the moving image data corresponding to the chapter data of the chapter number n (S25).

On the other hand, when proceeding to S27, the CPU 114 displays a message indicating the normal reproduction without chapter skip (for example, “Reproduce data as it is without skip”) on the LCD 109 (S27). Subsequently, the CUP 114 instructs the HDD 105 and so on to reproduce the designated moving image data without chapter skip, that is, without skipping it (S28).

Next, the CPU 114 judges whether or not the release password has been set (S29). When the release password has been set here, the CPU 114 requests the user to input the release password by displaying a predetermined message on the LCD 109 (S31). When no release password has been set, the CPU 114 instructs the HDD 105 and so on to reproduce all the chapters of the designated moving image data (S30).

The CPU 114 then performs the operation as a judging unit to judge whether the release condition for releasing the skip setting is established or not depending on whether or not the release password matches the inputted password using the operation device 115. When the release password matches the inputted password, the CPU 114 recognizes that the release condition is established, so that the CPU 114 instructs the HDD and so on to reproduce all the chapters of the designated moving image data, and otherwise ends the operation without performing reproduction.

Since the camera apparatus 100 performs the above-described operations, the skip reproduction of the moving image data is performed by the user performing the operation of pressing the PLAY key without the long pressing. In this case, it is assumed that, for example, moving image streams 711, 712, 713, 714, and 715 are arranged in a time sequence along a time axis t, and chapter data 721, 722, 723, 724, and 725 are stored in a chapter table 730 as shown in FIG. 10. The chapter data 721, 722, 723, 724, and 725 shall be data determining reproduction start points of the respective moving image streams 711, 712, 713, 714, and 715 as shown in FIG. 10.

The moving image streams 711, 712, 713, 714, and 715 constitute the chapters partitioned with the GOPs corresponding to the chapter data 721, 722, 723, 724, and 725 as borders.

It is assumed here that chapter skip flags 721a, 723a, and 725a for the chapter data 721, 723, and 725 are OFF and the chapter skip flags 722a and 724a for the chapter data 722 and 724 are ON as shown in FIG. 10.

In the above case, while the moving image steams 711, 713, and 715 corresponding to the chapter data 721, 723, and 725 are reproduced, the moving image streams 712 and 714 corresponding to the chapter data 722 and 724 are skipped as the chapters for which the skip setting has been performed and accordingly not used for reproduction of the operation data.

As described above, the user only generates chapter data, and sets the skip flag to ON for the chapter data of the chapter that the user does not want to reproduce to thereby performs skip setting in the chapter that the user does not want to reproduce, whereby the camera apparatus 100 no longer reproduces the moving image of that chapter. Accordingly, the camera apparatus 100 can be configured not to reproduce the video that is unsuitable for reproduction, while leaving the original moving image data as well as requiring less labor and time.

As described above, with the camera apparatus 100, performance of the above-described skip reproduction makes it possible to perform reproduction of the moving image in a digest-like version to reproduce only the portion that the user wants another person to see. Further, it is also possible to easily perform skip reproduction of the portion that the user does not want another person to see.

Further, setting of the release password in advance prevents the moving image from being reproduced even if the skip setting has not been performed (S29 to S32). This prevents the video unsuitable for reproduction, such as a private portion from being reproduced to thereby protect it.

The user does not need to perform edit work of cutting portions unsuitable for reproduction when performing the skip reproduction, and therefore can substantially reduce the work time. In addition, the original moving image can be left intact.

The setting of the chapter skip is very simple because it can be performed only by setting of ON and OFF of the chapter skip flag for each chapter data.

Further, the camera apparatus 100 is configured to be able to realize two kinds of reproduction operations such as the skip reproduction and the normal reproduction depending on the pressing time of the PLAY key 119. In this case, the PLAY key 119 constitutes a selection operation device capable of performing operation for selecting the skip reproduction and the normal reproduction.

Note that the above-described camera apparatus 100 includes the HDD 105 as an external memory capable of reading/writing data on a random access basis, and it may include a DVD drive that records data into a DVD, (Digital Versatile Disk) as well as the HDD 105. The DVD drive may then store the moving image data into a rewritable storage medium such as a DVD-RW, DVD-RAM, or the like.

The description in the above is to describe the embodiments of the invention and, in no case, limits the apparatus and method of the invention, so that various modifications can be embodied with ease. Further, the apparatus and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera apparatus comprising a reproduction control unit for conducting control such that when skip setting for skip-reading a portion of moving image data has been performed for a particular chapter of moving image data indicating a shot video, the shot video is reproduced without using the moving image data constituting the chapter for which the skip setting has been performed.

2. A camera apparatus, comprising:
a moving image data generating device for generating moving image data indicating a shot video;
a chapter data generating unit for generating chapter data determining a reproduction start point in the moving image data generated by said moving image data generating device; and
a reproduction control unit for conducting control such that when skip setting for skip-reading a portion of moving image data has been performed for the chapter data, the shot video is reproduced without using corresponding moving image data corresponding to the chapter data for which the skip setting has been performed.

3. The camera apparatus according to claim 1, further comprising:
a skip setting unit for performing the skip setting.

4. The camera apparatus according to claim 2, further comprising:
a skip setting unit for performing the skip setting.

5. The camera apparatus according to claim 1, further comprising:
a skip setting release unit for releasing the skip setting.

6. The camera apparatus according to claim 2, further comprising:
a skip setting release unit for releasing the skip setting.

7. The camera apparatus according to claim 2, wherein said reproduction control unit conducts control such that when release condition for releasing the skip setting is established, the shot video is reproduced using the corresponding moving image data.

8. The camera apparatus according to claim 7, further comprising:
a judging unit for judging whether or not the release condition is established; and
a password input device for inputting a password,
wherein said judging unit judges that the release condition is established when the inputted password inputted by said password input device matches a release password for releasing the skip setting.

9. The camera apparatus according to claim 8, further comprising:
a password setting unit for setting the release password.

10. The camera apparatus according to claim 8, further comprising:
a password release unit for releasing the release password.

11. The camera apparatus according to claim 2, further comprising:
a selection operation device capable of performing operation for selecting skip reproduction to reproduce the shot video without using the corresponding moving image data or normal reproduction to reproduce the shot video using the corresponding moving image data.

12. A reproduction control method in a camera apparatus including a moving image data generating device for generating moving image data indicating a shot video, said reproduction control method comprising:
conducting control such that when skip setting for skip-reading a portion of moving image data has been performed for a particular chapter of moving image data indicating a shot video, the shot video is reproduced without using the moving image data constituting the chapter for which the skip setting has been performed.
